(19) United States
(12) Patent Application Publication
(10) Pub. No.: US 2014/0271099 A1
(43) Pub. Date: Sep. 18, 2014

(54) DEVICES AND METHODS FOR USE IN BIN SWEEP OPERATIONS

(71) Applicant: POET RESEARCH, INC., Sioux Falls, SD (US)

(72) Inventors: Michael Dwight Vander Vorste, Sioux Falls, SD (US); Jason C. Wolf, Garretson, SD (US); Joel A. Bordewyk, Windom, SD (US)

(21) Appl. No.: 14/199,382

(22) Filed: Mar. 6, 2014

Related U.S. Application Data
(60) Provisional application No. 61/777,527, filed on Mar. 12, 2013.

(51) Int. Cl. B65G 65/00; B65G 65/46; B65G 65/40

(52) U.S. Cl. CPC B65G 65/005; B65G 65/40; B65G 65/466
USPC 414/808

(57) ABSTRACT

A method of controlling entry of a bin entrant into a bin in which a bin sweep is located and controlling operation of the bin sweep by the bin entrant within the bin, the method including the steps of providing a system that includes a bin sweep, a human safe relay for removing power from the bin sweep, a Class II, Division 1 rated device that removes power from the bin sweep, motor safety controls to selectively energize and de-energize at least one motor of the bin sweep, an activation member with a predetermined stand-off distance from the bin sweep, and operating procedures that include a list of operations to be followed by the bin entrant and an entry attendant located outside the bin, the bin entrant and entry attendant performing the operations of the operating procedures.

### CROSS-REFERENCE TO RELATED APPLICATIONS

This application claims the benefit of U.S. Provisional Patent Application No. 61/777,527, filed Mar. 12, 2013 and titled “DEVICES AND METHODS FOR USE IN BIN SWEEP OPERATIONS” which application is incorporated herein by reference in its entirety.

### TECHNICAL FIELD

The present invention relates generally to grain bin sweeps. More specifically, the invention relates to devices and methods that can be used in bin sweep operations that include operator involvement within the bin.

### BACKGROUND

Grain bins are used for long-term and short-term storage of large volumes of grain, and typically include one or more bin outlets used for unloading the grain from the bin. These outlets can include a number of different configurations, but are typically designed so that after the outlets are opened, the weight of grain above the outlets pushes the grain to the outlets and out of the bin. Once the volume of grain has decreased to a certain level within the bin, however, the force of gravity is not sufficient to force the grain to flow from the outlets, and other means are then needed to move the remaining grain to the outlets and from the bin. This assisted movement of grain can be facilitated through the use of a system or device referred to as a grain bin sweep or simply as a bin sweep. In some cases, such as in particularly large cylindrical grain bins, a bin sweep can include an elongated auger that extends radially from the center area of the bin. Rotating the auger about its longitudinal axis will rotate the bin sweep within the bin to move the grain toward the bin outlets. Such bin sweeps can be automated for at least a portion of this grain movement process, but may additionally require the assistance of a human operator to push the sweep through difficult areas due to packed grain and/or uneven bin floors. This type of bin sweep may also be referred to as a sweep auger, which is typically a relatively large elongated sweeping device with an auger extending along its length. The bin sweep may be attached in the central area of the bin so that it can pivot or rotate about this center area, and an operator can assist the bin sweep in moving along that path.

Current bin sweep methods may also require an operator to use a device attached to a bin sweep to help jog portions of the grain over uneven floors or help to push through packed grain. There are safety concerns with such an operator being in the bin while the open auger sweep remains energized. As a result, the federal Occupational Safety and Health Administration (OSHA) has ruled that a person cannot enter a bin while such equipment is energized without the use of an approved safety method. Thus, there is a need to provide methods and devices that allow for safe access to a grain bin by a human operator while a bin sweep is energized.

### SUMMARY

In one aspect of the invention, a method for operating a bin sweep within a grain bin is provided, along with associated equipment and control systems, which allow for safe operation by a human operator within the bin while the bin sweep is energized. This method includes the use of a human safe relay or switch that can remove power from the bin sweep. Such a relay or switch can be Class II, Division 1 rated. The device can include additional motor safety controls that will provide assurance that any motors used to energize the bin sweep can be de-energized when desired. One embodiment of a device that can be used for such an operation is an activation member or T-bar that is configured so that the human operator is at an appropriate stand-off distance (e.g., seven feet) from the auger. The operating procedures of the invention further include testing of a safety device before the operator enters the bin, conducting a hole watch for the safety of that operator, and providing a secondary external cut-off switch. The operator will wears appropriate personal protective equipment while in the bin, covers conveyor drop holes as they are revealed or uncovered, and removes product falling hazards.

In methods of the invention, appropriate operating procedures are provided, which include energizing an activation member or T-bar that the operator controls to move the bin sweep while it is energized. Both the bin sweep operator, who is controlling the T-bar, and the entry attendant, who is in communication with the bin sweep operator and controlling entry and exit of the bin sweep operator, have direct control of the motor controller that controls the bin sweep equipment.

In an aspect of the invention, a method is provided for controlling safe entry of a bin entrant into a bin in which a bin sweep is located and controlling operation of the bin sweep by the bin entrant within the bin. The method comprises the steps of providing a system that includes a bin sweep, a human safe relay that removes power from the bin sweep, a Class II, Division 1 rated device that removes power from the bin sweep, motor safety controls to selectively energize and de-energize at least one motor of the bin sweep, an activation member with a predetermined stand-off distance from the bin sweep, and operating procedures comprising a list of steps to be followed by the bin entrant and an entry attendant located outside the bin. The method further includes the bin entrant and entry attendant performing the steps of the operating procedures.

### BRIEF DESCRIPTION OF THE DRAWINGS

The invention will be explained with reference to the appended Figures, wherein like structure is referred to by like numerals throughout the several views, and wherein:

FIG. 1 is a schematic, perspective, partial cut-away view of a grain bin with an operator controlling a bin sweep, in accordance with the invention;

FIG. 2 is an enlarged view of a portion of the grain bin illustrated in FIG. 1; and

FIG. 3 is a perspective view of an embodiment of an activation member or T-bar controller of the invention.

### DETAILED DESCRIPTION

Referring now to the Figures, wherein the components are labeled with like numerals throughout the several Figures, and initially to FIG. 1, a bin sweep operation or system involving a bin 10 is illustrated with a partially cut-away view of the inside of a portion of the bin 10. The system generally includes the bin 10, which can be a typical cylindrical grain bin with a horizontal floor from which a curved metal structure upwardly extends, as shown, or can have a different shape, such as a bin that includes a square or rectangular shape for its base or floor, and corresponding sides that extend upwardly from the base or floor. The bin 10 includes walls made generally of solid pieces of material (e.g. sheet metal) with one or more bin outlets through which grain can be unloaded from the interior of the bin 10. These outlets can include a number of different configurations, but are typically designed so that after the outlets are opened, the weight of grain above the outlets pushes the grain to the outlets and out of the bin. However, when the volume of grain has decreased to a certain level within the bin, the force of gravity will often not be sufficient to force the grain to flow from the outlets. At this point, a bin sweep 14 can be activated to move grain toward a central or otherwise located bin outlet. In order to provide additional force and guidance of the bin sweep 14, a bin sweep operator 12 can enter the bin 10 to control the bin sweep 14 to move the remaining grain to the outlets and from the bin, as will be described in further detail below. The bin sweep 14 can be controllable by a device, such as an activation member or T-bar, which is activated by an operator.

The bin 10 further includes an access opening 16, which may otherwise be referred to as a “bin manway”, in that it is an access hole in the side of the bin 10 through which a person can enter and exit the interior space of the bin 10. One or more safety switches 18 can be positioned immediately outside this access opening 16, where they can be accessible for activation by an entry attendant 20. In this configuration, the access opening 16 and safety switch 18 are located at the top of a ladder and platform 22, although the system may be configured differently.

As is further illustrated in FIG. 1, the bin sweep 14 includes an elongated member 24, which may include an auger or other grain-moving apparatus that may be at least partially surrounded by a cover 26. The system may further include a bin sweep activation member 28 that is held at one end by the bin sweep operator 12 and which is attachable to and detachable from the elongated member 24 of the bin sweep 14. The activation member 28 may have a number of different configurations, such as the exemplary embodiment of an activation member or T-bar 28 illustrated in FIG. 3. T-bar or activation member 28 includes a release lever 32 at a proximal end 34 (i.e., the end that will be held by an operator), an elongated bar 36 extending from the release lever 32 to a distal end 38 of the T-bar 28, and a switch 40 positioned on the elongated bar 36 between the proximal end 34 and the distal end 38. This switch 40 can be a human safe, Class II, Div.1 rated switch, for example. The distal end 38 of the T-bar 28 is configured to provide removable attachment with the bin sweep 14. Motor controls 42 for the bin sweep 14 are illustrated schematically with a box located outside the bin 10 (see FIG. 1).

Bin sweeps of the invention may include an activation member having a different configuration than the T-bar described and illustrated herein. For example, the activation member can be a wedge-shaped member, can have a frame extended away from the plane, and/or can include one or more wheels. These and other activation member configurations are used to provide the operator with a hand-activated apparatus with which the bin sweep can be controlled.

The release lever 32 of this embodiment includes a stationary member 29 and a moveable member 30 that can pivot toward and away from the stationary member 29 when manipulated by an operator. The release lever 32 is held down or activated by the action of an operator grasping the moveable member 30 and squeezing it toward the stationary member 29. When this occurs, the release lever 32 and safety switch 40 can send a signal to contactors of the motor controls 42, which will allow the motor(s) of the bin sweep 14 to run. In operation, the bin sweep operator 12 can activate the T-bar 28 by grasping the release lever 32 and moving it to an activated position, which will close the signal path and cause the bin sweep motor(s) to run. If the bin sweep operator 12 allows the release lever 32 to return to its starting position (e.g., by releasing the lever, which allows the moveable member 30 to pivot away from the stationary member 29 due to an optional spring-biased configuration of the release lever 32), the signal path will open, which will cause the motor control contactors to remove power from the bin sweep motor(s). Power can also be removed from the bin sweep motor(s) if certain types of failures occur. In addition, the entry attendant 20 will have immediate access to an emergency stop switch, which may be hand or foot operated, for example. Thus, redundant motor control contactors can be used to disable power to the bin sweep motor(s).

Referring additionally to FIG. 2, an enlarged view of the interior area of bin 10 is shown with the bin sweep 14 being controlled by the bin sweep operator 12. Specific exemplary operating distances are illustrated in this Figure, which are not necessarily shown to scale. In particular, a first controlled zone 50 is illustrated immediately adjacent to the elongated member 24 and on the opposite side of the elongated member 24 from where the operator 12 is positioned. No person is permitted in the first controlled zone 50, as this is the direction that the bin sweep 14 will be moving when activated, and is therefore a potentially dangerous area for a person to be located. A second controlled zone 52 is illustrated immediately adjacent to the elongated member 24 and on the same side of the elongated member 24 as the operator 12. This zone 52 extends along the entire length of the elongated member 24 and for a distance from the elongated member 24 toward the operator that is designated by the reference number 54. Again, no person is permitted in this zone 52, as it is considered to be a potentially dangerous area for a human operator. The distance 54 can be seven feet or larger, for example, and can also be referred to as a “stand-off” distance of the operator.

Methods of the invention further include at least one specific standard operating procedure that defines particular steps that are to be followed for proper and safe usage of an activation member 28 with a bin sweep 14 during a bin sweep procedure. In particular, the procedure defines the first controlled zone 50 as the area in front of the elongated member 24 or bin sweep auger, and defines the second controlled zone 52 as the area immediately adjacent to the elongated member 24 and toward the operator as a predetermined distance, such as a distance of seven feet. The procedure defines the area beyond the second controlled zone 52 as a “safe zone” 56, which is the area in which an operator can safely control the bin sweep 14.

The methods of the invention further include a number of safety steps to be performed prior to entry of any operators into a bin, which are described relative to the exemplary bin 10 illustrated in FIGS. 1 and 2. One such step includes performing specified lockout-tagout (LOTO) procedures prior to opening the access opening 16. Lockout-tagout procedures are used to ensure that the bin sweep 14 is properly shut off or de-energized and so that it is not started up prior to completion of other steps in the process.

The bin 10 is then inspected for engulfment hazards, after which a bin entry permit can be completed. The bin entry permit includes procedures that will be performed by the bin entrant or bin sweep operator 12, such as wearing the correct personal protective equipment, which may include a rescue harness in certain situations. An entry attendant 20 will then be positioned in a location outside the bin 10 where he or she can access the emergency stop device(s). The bin entrant will then be permitted to enter the bin via the access opening 16.

Once the bin entrant 12 has entered the bin 10, the bin entrant 12 will remain in radio communication with the entry attendant 20 at all times. Upon a first entry into the bin 10, the bin sweep 14 will likely not include any type of device attached to it that can be used to control it. Thus, the bin entrant 12 will attach or install the activation member 28 (e.g., T-bar member) to the bin sweep 14, then will inspect the interior area of the bin 10 for any hazards, and then will then exit the bin 10 via the access opening 16. If the bin entrant 12 did not find any hazards in the bin, the bin entrant 12 will then remove the lockout-tagout device and re-enter the bin 10. Once in the bin 10, the bin entrant 12 will not enter either of the first and second controlled zones 50, 52, but instead will remain in the safe zone 56. The bin entrant 12 can then move immediately to the activation member or T-bar 28, which will not be activated, and therefore will be in its safe or open position.

At this point, the activation member 28 will be tested by the bin entrant 12 to verify that the motors do not start with the activation member 28 is in its safe or open position. The bin entrant 12 will note that this test of the activation member 28 is successful by entering this information on an entry permit. The activation member 28 will be tested in this manner every time the bin entrant 12 leaves and re-enters the bin. The bin entrant 12 will remain at the proximal end 34 of the activation member 28, where he or she can grasp the release lever 32. The release lever 32 can then be grasped and activated by the bin entrant 12, thereby allowing activation of the bin sweep 14. The bin operator 12 will be grasping this release lever the entire time the bin sweep 14 is energized or activated. Should the bin entrant 12 need to move away from the release lever 32 for any reason, such as to cover a sump hole or outlet 60, the bin entrant 12 will communicate this intent to the entry attendant 20 and receive acknowledgement of this communication before leaving the area of the bin sweep 14.

With regard to the holes 60 (e.g., sump holes) that are discussed herein, these holes 60 can be uncovered as the bin entrant 12 is operating the bin sweep 14 and moving grain to expose areas that were not previously exposed. As the bin sweep 14 moves forward such that one or more holes 60 are positioned in the safe zone 56, the bin entrant 12 will cover these holes 60, such as with portable steel covers that are staged within the bin 10. As discussed above, in order to cover the holes 60 in this way, the bin entrant 12 will need to release the release lever 32, which will be communicated by the bin entrant 12 to the entry attendant 20.

During the assisted bin sweep operation, the bin entrant 12 will provide push assistance using the activation member 28, as needed. Once the grain in the bin 10 appears to be at a level where the bin sweep 14 can again operate effectively without the assistance of an operator in the bin, the bin entrant 12 will communicate with the entry attendant 20 to inform him or her of this situation, and then the bin entrant 12 can exit the bin 10 via the access opening 16. The bin sweep lockout-tagout procedures will then be performed per specific lockout-tagout rules. Once the bin sweep 14 has been deactivated, the bin entrant 12 will re-enter the bin to remove the activation member 28, after which he or she can exit the bin 10. Once again, the bin sweep lockout-tagout is removed, and the bin sweep 14 can then operate automatically within the bin 10 without the assistance of an operator. Each time the bin sweep 14 does not operate effectively and operator assistance is desired, the lockout-tagout procedures must be performed prior to entry by the bin entrant 12.

As set out above, this method of the invention provides a number of sequential steps designed to provide for safe entry of a human operator within a bin, where the bin entrant or operator is allowed to energize or activate the bin sweep while in the bin. In this operation, appropriate physical devices are used (e.g., safety switches, a designated stand-off distance, lockout-tagout procedures, and the like), along with an operating procedure that provides for the safety of a bin entrant and safe use of an activation member or T-bar to assist the bin sweep while it is energized.

The present invention has now been described with reference to several embodiments thereof. The entire disclosure of any patent or patent application identified herein is hereby incorporated by reference. The foregoing detailed description and examples have been given for clarity of understanding only. No unnecessary limitations are to be understood therefrom. It will be apparent to those skilled in the art that many changes can be made in the embodiments described without departing from the scope of the invention. Thus, the scope of the present invention should not be limited to the structures described herein, but is further intended to encompass equivalents of those structures.

1. A method of controlling entry of a bin entrant into a bin in which a bin sweep is located and controlling operation of the bin sweep by the bin entrant within the bin, the method comprising the steps of:
providing a system that comprises:
a bin sweep comprising at least one motor;
a human safe relay for removing power from the bin sweep;
motor safety controls to selectively energize and de-energize the at least one motor of the bin sweep;
an activation member removably attachable to the bin sweep, the activation member providing a predetermined stand-off distance from the bin sweep; and
operating procedures comprising a list of steps to be followed by the bin entrant and an entry attendant located outside the bin; and
the bin entrant and entry attendant performing the steps of the operating procedures.

2. The method of claim 1, wherein the relay comprises a Class II, Division 1 rated device.

3. The method of claim 1, wherein the activation member comprises a T-bar member.

4. The method of claim 1, wherein the activation member comprises an elongated bar having first and second ends, a release lever extending from a first end of the bar, and a switch positioned on the bar between its first and second ends.

5. The method of claim 4, wherein an attachment member extends from the second end of the elongated bar, wherein the attachment member is removably attachable to the bin sweep.

6. The method of claim 4, wherein the release lever comprises a first member and a second member that is pivotally moveable relative to the first member, wherein the first and second members are biased relative to each other such that the release lever comprises:
an operating position in which the first and second members are pivoted toward each other against the bias; and
a neutral position in which the first and second members are pivoted away from each other in response to the bias.

7. The method of claim 6, wherein movement of the release lever to the neutral position comprises opening a signal path and removing power from the at least one motor of the bin sweep.

8. The method of claim 6, wherein movement of the release lever to the operating position comprises sending a signal to activate the at least one motor of the bin sweep.

9. The method of claim 1, wherein the operating procedures comprise safety device testing prior to the bin entrant entering the bin, use of a secondary external cut-off switch, use of predetermined personal protective equipment by the bin entrant, and covering of conveyor drop holes as the holes are revealed within the bin.

10. The method of claim 1, wherein the method further comprises the step of performing specified lockout-tagout procedures prior to opening an access opening of the bin.

11. The method of claim 1, further comprising the step of designating a safe zone beyond the stand-off distance.

12. The method of claim 1, wherein the stand-off distance is at least seven feet.

13. The method of claim 1, wherein an inner area of the bin comprises a volume of grain.

14. The method of claim 1, wherein the bin sweep comprises an elongate auger.

15. The method of claim 1, wherein the step of performing the steps of the operating procedure comprises attaching the attachment member to the bin sweep, and then activating the activation member to energize the at least one motor of the bin sweep.
